(19) United States
(12) Patent Application Publication
(10) Pub. No.: US 2007/0055412 A1
(43) Pub. Date: Mar. 8, 2007

(54) Lane device, selector device and method for detecting the lane of a vehicle

(76) Inventor: Werner Bernhard, Filderstadt (DE)

Correspondence Address: FITCH, EVEN, TABIN & FLANNERY, P. O. BOX 18415, WASHINGTON, DC, 20036, US

(21) Appl. No.: 10/579,834

(22) PCT Filed: Nov. 9, 2004
(86) PCT No.: PCT/EP04/12654

§ 371 Date: May 17, 2006

(30) Foreign Application Priority Data
Nov. 20, 2003 (DE) 10354290.6

(51) Int. Cl. G06F 17/00

(52) U.S. Cl. 701/1; 701/301

(57) ABSTRACT

The invention relates to a lane device (30) and a method for detecting the lane of a vehicle (10), as well as to a selector device which interacts with the lane device (30). The lane device (30) contains evaluation means (32, 35, 37) for evaluating distance data (60, 61, 66) of at least one distance sensor (58, 59, 65), it being possible to determine a lateral distance (d1-d4) from a reference body (62, 64) which runs essentially continuously to the side of the lane, at least in sections, from the distance data (60, 61, 66). The evaluation means (32, 35, 37) are configured to acquire lane data (36) as a function of the distance data (60, 61, 66). According to the invention, the evaluation means (32, 35, 37) are configured to filter out interference information, caused in particular by vehicles (17) present in the region of the lane or discontinuities (63) of the reference body (62, 64), from the distance data (60, 61, 66).

The invention relates to a lane device and a method for detecting the lane of a vehicle as well as to a selector device which interacts with the lane device.

Known lane devices are used to guide a passenger vehicle or utility vehicle along a lane. In order to guide a track free vehicle along a lane it is known, for example from DE 30 42 723 A1, to guide said vehicle automatically along a guiding cable which is laid in the road bed. The vehicle is steered as a function of the guiding cables. However, a guiding cable is present only in rare cases so that such lane guidance is the means for the selection only in specific applications, for example with respect to the lane guidance of buses (DE 30 42 723 A1) or in a load transportation vehicle for a storage system, for example in conjunction with a high bay store, such as is disclosed by DE 26 49 595 A1. For this reason, other lane guiding systems propose that, for example, a video camera or the like, that is to say an optical system, be used. Such a system is known, for example, from EP 1 074 904 B1. However, when it is dark such a system can generally be used only if the sensitivity of the video camera to light is sufficient.

The document U.S. Pat. No. 6,138,062 describes a lane device for guiding a vehicle along a lane. For this purpose, the lane device has two optical sensing means. With the first sensing means which is embodied as a CCD camera the marking lines which are present on carriageways and are preferably white are sensed. The profile of the sensed marking lines is evaluated and the information which is acquired in the process is used to actuate a steering device in such a way that the vehicle automatically follows the course of the road as is apparent from the marking lines. If it is not possible to sense the marking lines, the automatic line guidance of the vehicle is carried out by means of a second sensing means which is embodied as a laser radar device and with which the distance between the vehicle and sidewalls which are located along the carriageway is determined. The data which describes the distance between the vehicle and the sidewalls is then used to carry out the lane guidance of the vehicle. By virtue of the second sensing means, this lane device can be used independently of the prevailing light conditions. However, with this lane device it is not ensured that it operates reliably in difficult light conditions even if, for example, the sidewalls with respect to which the distance is sensed using the second sensing means have discontinuities and there is therefore inference information in the sensed distance data. Such situations occur, for example, when traveling in a tunnel, the discontinuities being caused by projections or cavities in the tunnel wall. Discontinuities can also be caused by oncoming or overtaking vehicles. In addition, discontinuities can also occur owing to gaps in a barrier or owing to lowered curb stones. Corresponding precautions for ensuring reliable operation of the lane device even in these situations are not specified in U.S. Pat. No. 6,138,062.

The object of the present invention is therefore to make available a lane device for determining the lane of a vehicle which operates reliably even in difficult ambient conditions, and for improving further existing lane devices which are provided for use in difficult ambient conditions. The ambient conditions are intended to include the light conditions, the state of building of the carriageway or along the carriageway and the state of the carriageway or parts of the carriageway. In particular, the lane device according to the invention should also operate reliably in the dark and/or in the tunnel and/or when carriageway markings or the like are soiled.

The above object is achieved by means of a lane device for detecting the lane of a vehicle, has the evaluation means for evaluating distance data of at least one distance sensor, it being possible to determine a lateral distance from a reference body which runs essentially continuously to the side of the lane, at least in sections, from the distance data. The evaluation means are configured to acquire lane data as a function of the distance data. According to the invention, the evaluation means are configured here to filter out interference information, caused in particular by vehicles present in the region of the lane or discontinuities of the reference body, from the distance data. This ensures that the lane data which is acquired as a function of the distance data does not contain any interference information which could lead to a malfunction of the lane device.

In addition, the object is achieved by means of a corresponding method. Furthermore, a selector device which interacts with the lane device and assigns distance data of the distance sensor to the lane device or to a parking aid device is provided for achieving the object.

The lane device according to the invention uses, for example, curbstones along the carriageway on which the vehicle is moving, a tunnel wall, a crash barrier or the like as reference body for the purpose of orientation. Such reference bodies run essentially continuously. The evaluation means acquire lane data from the distance data which contains one or more distances from one or more reference bodies. This lane data is transmitted, for example to a navigation system or a transverse control system of the vehicle. Such a transverse control system can also be a component of a lane device according to the invention. Such a lane device is also referred to as a lane follower system. The lane device carries out steering interventions in order to keep the vehicle, for example a passenger car or utility vehicle, on the desired lane.

The distance data may have a certain degree of interference or not be plausible. Interference information may be caused, for example, by oncoming vehicles, vehicles which are overtaking the vehicle which is configured according to the invention, or the like. In addition, discontinuities may be present on the reference body or bodies, for example there may be gaps

in a crash barrier, projections or recesses in a tunnel wall, lowered curb edges or the like. A number of solutions which can be combined with one another are proposed for filtering out such interference information:

For example a high pass filter can be provided for filtering out high frequency interference information. Such high frequency interference information is caused, for example, by the vehicle moving at a high velocity along a tunnel wall and the tunnel wall having a narrow projection. However, a low pass filter is also advantageous for filtering out low frequency interference information. Such low frequency interference may be caused, for example, by a vehicle which is overtaking the vehicle configured according to the invention at a low relative velocity.

Plausibility checking is also preferred. During plausibility checking, for example different distance data from a plurality of distance sensors are evaluated. If the distance data of one sensor differs from the distance data of the other distance sensor significantly, this differing distance data is filtered out.

A further preferred variant provides for the lane data or the distance data to be compared with stored lane data. The stored lane data extracts the lane device according to the invention from a digitized road map, for example.

The distance sensor preferably operates in a range of invisible or inaudible frequencies. In particular, using invisible frequencies has the advantage

that the acquisition of the distance data is at least independent of the ambient light. The same also applies to the use of a distance sensor which operates in the range of inaudible frequencies. At the same time, these frequency ranges ensure that disruption to the driver or to other road users is ruled out.

The distance sensor is, for example, an ultrasonic sensor, a radar sensor or an infrared sensor. It is also possible for a plurality of different sensors of the abovementioned designs to be applied in combination with one another.

The lane device according to the invention preferably becomes active when a wirefree locating system, for example on the basis of the GPS system (Global Positioning System) or of an optical detection system, for example one or more video cameras, is not active. The wirefree locating system is, for example, no longer active in a tunnel. The optical system can no longer operate, for example, owing to an absence of carriageway marking, or to soiled carriageway marking, to unfavorable lighting or to difficult light conditions.

The lane device according to the invention expediently contains one or more distance sensors. However, a particularly preferred variant of the invention provides for the lane device according to the invention to utilize distance sensors of a parking aid device. This results, in these distance sensors being utilized, on the one hand, by the parking aid and, on the other hand, by the lane device so that overall a double use occurs. A parking aid device usually has a plurality of distance sensors which are oriented primarily in the forward travel direction of the vehicle and in the reverse travel direction of the vehicle. In addition, distance sensors which act obliquely rearward or obliquely forward are customary. The distance data of these distance sensors which also cover lateral areas of the surroundings of the vehicle are particularly relevant to the lane device according to the invention so that a preferred variant of the invention provides for the lane device to evaluate the distance data as a function of the position of the distance sensor on the vehicle. It is also expedient to weight the distance data as a function of the respective position of the distance sensor.

The above idea can be summarized in a generalized fashion as follows: a distance sensor, which is the component of parking aid device arranged in a vehicle, is used to make available distance data which is fed to a lane device which is also arranged in the vehicle, the lane device acquiring, from this distance data, lane data for determining a lane along which the vehicle is guided.

A further variant of the invention falls back on the knowledge that a vehicle transverse control system is desired, in the particular at relatively high vehicle velocities, while a parking aid device is active essentially at low vehicle velocities. Correspondingly, there is advantageously provision that the lane device which evaluates distance data of the distance sensor or sensors as a function of the velocity of the vehicle, evaluates distance data, for example, only if the vehicle is moving forwards at at least a predetermined velocity.

One variant of the invention provides that the distance data of the distance sensors is evaluated by a selector device which is separate from the lane device and the parking aid device and is assigned to the lane device and/or the parking aid device as a function of one or more criteria. For example, the selector device transmits the distance data to the parking aid device at a low velocity of the vehicle and to the lane device at a high velocity. As a further criterion of the invention it is possible for the selector device according to the invention to evaluate the position of the distance sensors. For example, distance data from laterally arranged distance sensors is transmitted to the lane device, and distance data from distance sensors arranged on the front or rear of the vehicle is transmitted to the parking aid device.

An exemplary embodiment of the invention is explained in more detail below with reference to the drawing in which:

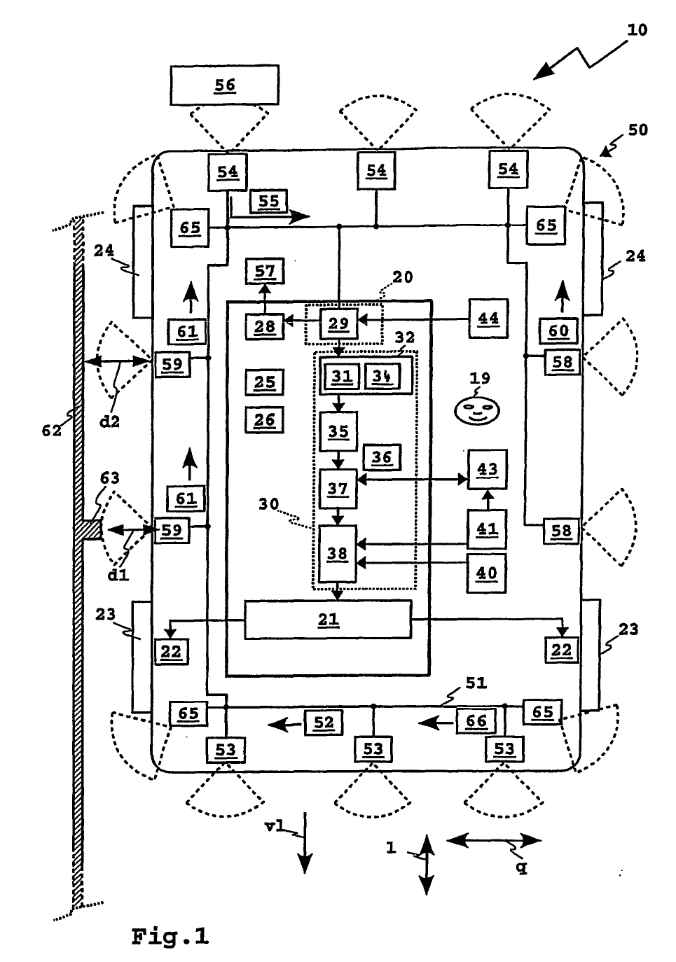

FIG. 1 is a schematic illustration of a vehicle which is equipped with a lane device according to the invention, and

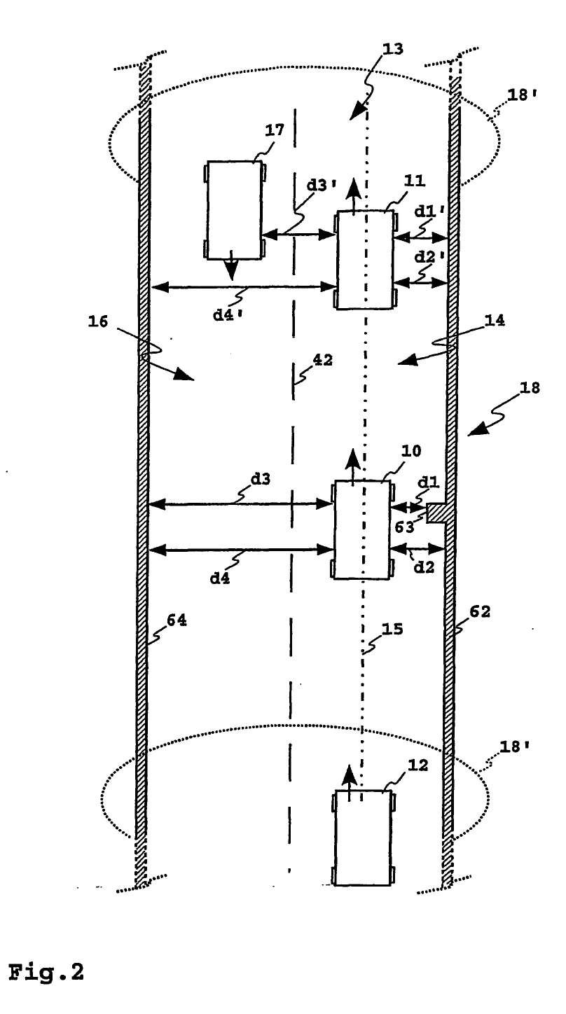

FIG. 2 shows a driving situation in a tunnel section, before which and in which a plurality of vehicles according to the invention are moving.

FIG. 2 illustrates vehicles 10, 11, 12 which are moving one behind the other on a carriageway 13 of a road 14. The travel direction of the vehicles 10 to 12 is indicated by short arrows. A vehicle 17 is coming towards the vehicles 10 to 12 on a carriageway 16 of the road 14.

The road 14 preferably runs in tunnels, for example in a tunnel section 18 located between tunnel entrances 18′. Outside the tunnel section 18 the vehicles 10, 11, 12, which are of theoretically identical design in the exemplary embodiment, detect their respective lane 15 by means of, for example, optical detection systems, wirefree locating systems or the like. Information about the course of the lane 15 is expedient, for example, for navigation systems and/or steering systems devices of the vehicles 10, 11, 12. Within the tunnel section 18 the abovementioned locating systems, which are, for example, supported by radio or operate using optical principles, can, however, not be used. The invention remedies this:

For example, for the purpose of explanation, the functional assemblies—illustrated schematically in FIG. 1—of the vehicles 10 to 12 will be explained in more detail for vehicle 10.

The vehicle 10 is, for example, a passenger car, a utility vehicle or the like with an internal combustion engine, electric motor or the like (not illustrated). The vehicle 10 can be controlled by a driver 19 who is supported in his driving tasks by a driving assistance device 20. The driving assistance device 20 may carry out, for example, steering corrections, stabilize the vehicle 10 (function of an ESP [electronic stability program] module), or control the vehicle 10 autonomously in one variant of the invention. In order to steer the vehicle 10, there is a steering control module 21 which steers front wheels 23 of the vehicle 10 by means of steering actuators 22. Here, rear wheels 24 of the vehicle 10 cannot be steered. In theory, the steering control module 21 can, however, also apply steering actions to steerable rear wheels.

Important functions of the driving assistance device 20 are implemented using software, a plurality of software modules being provided: the steering control module 21, a parking aid module 28 which forms a parking aid device and which provides support in parking the vehicle 10, a selector module 29 for selecting distance data which is acquired by distance sensors, and a lane module 30 which forms a lane device according to the invention. The program code of the modules 21, 28, 29, 30 is carried out by one or more processors 25 of the driving assistance device 20 and is stored in a memory 26, for example RAM Random Access Memory) and/or ROM (Read Only Memory).

The steering control module 21 requires lane data to steer the vehicle 10 along a lane. When the visibility is good and, for example, carriageway markings or the like can be detected, such lane data is transmitted by an optical detection system 40 which comprises, for example, one or more video cameras. In addition, the driving assistance device 20, in particular the steering control module 21, receives lane data from a locating system which operates in a wirefree fashion, for example a GPS receiver 41. However, it is not possible for lane data or location data which has been transmitted in a wirefree fashion to be received everywhere, for example not within the tunnel section 18. In addition, lane markings or the like cannot be detected so that the optical detection system 40 also remains ineffective. In such a situation, the driving assistance device 20 according to the invention preferably evaluates distance data from one or more distance sensors 50 which operate in the invisible or inaudible frequency range. Of course, the driving assistance device 20, however, can also evaluate distance data from one or more distance sensors 50 operating in the invisible or inaudible frequency range when the detection system 40 and/or the GPS receiver 41 are functioning normally.

The distance sensors 50 are, for example, infrared sensors, radar sensors, ultrasonic sensors or the like. The infrared sensors and the radar sensors being distance sensors which operate in a range of invisible frequencies and the ultrasonic sensors being sensors which operate in a range of inaudible frequencies. The distance sensors 50 are connected to the driving assistance device 20 by means of a bus system 51 and/or other connecting lines. The distance sensors 50 are effective, in particular, in the close range of the vehicle 10, for example at a distance of 0.03 to 3 meters, 0.06 to 5 meters, 0.2 to 7 meters or the like.

The distance data of the distance sensors 50 are partially relevant to the parking aid module 28 and partially to the steering control module 21. The selection and assignment of the respectively relevant distance data to the modules 28, 21 are carried out by the selector module 29. An assignment criterion is, for example, the position of the respective distance sensors 50 on the vehicle 10. For example, distance data which has been transmitted by distance sensors 53 arranged on the front of the vehicle 10 is transmitted to the parking aid module 28 by the selector module 29. The distance sensors 53 are orientated in the direction of the longitudinal axis 1 of the vehicle and have, for example, conical coverage areas, which are indicated by dashed lines. Distance sensors 54 which are arranged on the rear of the vehicle 10 cover the area behind the vehicle 10 and transmit distance data 55. In accordance with the orientation of the distance sensors 54 in the direction of the longitudinal axis 1 of the vehicle, the selector module 29 transmits the distance data 55 to the parking aid module 28. Behind the vehicle 10 there is, for example, an obstacle 56, for example another vehicle, a tree trunk or the like. The obstacle 56 is sensed by the distance sensors 54 and signaled to the driving assistance device 20 by means of the distance data 55. The selector module 29 transmits the distance data 55 to the parking aid module 28 which outputs distance information as a function of the distance data, for example using visual and/or audible output means 57. The output means 57 output in a manner known per se, for example at a distance-dependent frequency, warning tones, indicate the distance from the obstacle 56 visually or the like.

Lateral sensors 58, 59 which are arranged on the left or right of the vehicle 10 in the travel direction sense obstacle or reference bodies to the side of the vehicle 10. Coverage areas are also indicated for the distance sensors 58, 59 in a schematic fashion by means of dotted lines. The lateral distance sensors 58, 59 may have larger coverage areas in the direction of the transverse direction q of the vehicle than the front and rear distance sensors 53, 54 in the direction of the longitudinal axis 1 of the vehicle. Distance data 60, 61 which is transmitted by the distance sensors 58, 59 is primarily not relevant for the parking aid module 28 but rather predominantly for the lane module 30, and is correspondingly transmitted from the selector module 29 to the lane module 30. The distance data 61 which is transmitted by the distance sensors 59 contains, for example, information about lateral distances d2, d1 from a tunnel wall 62 of the tunnel section 18 or from a projection 63 on the tunnel wall 62. The distance data 60 which is transmitted by the lateral distance sensors 58 arranged to the left in the direction of travel contain, for example, information about lateral distances d3 and d4 of the vehicle 10 from a tunnel wall 64, lying opposite the tunnel wall 63, of the tunnel section 18. By means of the distance data 60, 61, the lane module 30 can acquire lane data 31 and feed to the steering control module 21 so that the steering control module 21 can steer the vehicle 10 along the lane 15. The distance data 60, 61 is also available if the optical detection system 40 or the GPS receiver 41 are ineffective.

Further distance sensors 65 are arranged obliquely to the front and obliquely to the rear, that is to say in the corner areas of the vehicle 10 and are respectively sensitive in the area of the vehicle 10 lying obliquely to the front or obliquely to the rear. The distance data 66 which is acquired by the distance sensors 65 can be relevant, on the one hand, to the parking aid module 28 and, on the other hand, to the lane module 30. In theory it would be possible for the distance data 66 to be sent to both modules 28, 30. However, this could involve a comparatively high processing burden under certain circumstances. Accordingly, the selector module 29 selects the distance data 66 as a function of a further criterion, specifically the longitudinal velocity v1 of the vehicle 10, for the parking aid module 28 and/or the lane module 30. At a low vehicle velocity v1, for example 10 km/h, the selector module 29 transmits the distance data 66 to the parking aid module 28, and at relatively high vehicle velocities v1, for example, higher than 20 km/h, it transmits said distance data 66 to the lane module 30. In an intermediate range, for example 10 km/h to 20 km/h in this case, the selector module 29 transmits the distance data 66 to both modules 28, 30. The selector module 29 receives the vehicle velocity v1 from a tachometer 44.

The tunnel walls 62, 64 form reference bodies which run essentially continuously. However, there may also be discontinuities, for example the wall projection 63 which has already been mentioned. If the vehicle 10 travels past the projection 63, the distance sensor 59 which lies at the front in the travel direction transmits distance data 61, and then the distance sensor 59 located at the rear in the travel direction transmits distance data 61, said distance data 61 containing the relatively short distance d1. This short term or high frequency change in the distance data 61 is filtered out of the distance data 61 by a high pass filter 31. The high pass filter 31 is contained in an input filter 32 of the lane module 30. The filter 32 also contains tracking means 34 which are effective in addition to or instead of the high pass filter 31. For example, the tracking means 34 determine that the distance d1 differs significantly from the distances d2 which are otherwise measured by the distance sensors 59, and accordingly gates out the distance data 61 containing the distance d1.

The optical detection system 40 orientates itself, for example, with one of the carriageway markings 42 which divide the carriageways 13, 16 from one another.

Converting means 35 convert the distance data 60, 61, 66 into lane data 36 which characterizes the carriageway 13 and/or the lane 15. To this extent, the conversion means 34 and the lane module 30 can be referred to as evaluation means for evaluating distance data.

Plausibility means 37 check the lane data 36 for plausibility by means of stored lane data 45. For example, the plausibility means 37 will receive, from a navigation system 43, data about a course of a carriageway which is stored, for example, in a digitized road map. That is to say the stored lane data 45 is stored in the navigation system 43. For reasons of clarity, the stored lane data 45 has not been illustrated in FIG. 1. If the carriageway data 36 differs significantly from this stored carriageway data, it is filtered out. Otherwise, the plausibility means 37 transmit the carriageway data 36 to selector means 38. The navigation system 43 can also receive the carriageway data 36 from the lane module 30 in order to be informed of the current position of the vehicle 10.

The selector means 38 select the carriageway data 36 for the lane module 30 when the optical detection system 40 and GPS receiver 41 are ineffective, for example within the tunnel section 18. It is also possible for the selector means 38 to carry out a plausibility check and to transmit the carriageway data 36 to, for example, a 2 from 3 selector means which transmit the carriageway data transmitted by the optical detection means 40 or the carriageway data transmitted by the GPS receiver 41 on to the steering control module 21.

Interference can also be caused by oncoming vehicles, for example as by the vehicle 17 in the case of the vehicle 11. Faults can also be caused by vehicles traveling in front.

The vehicle 11 is theoretically of identical design to the vehicle 10 and correspondingly has distance sensors 58 and 59. The sensors 59 signal two identical distances d1′ and d2′ from the tunnel walls 62 in the distance data 61. The distance sensor 58 which is located on the rear left in the travel direction of the vehicle 11 signals a distance d4′ from the opposite tunnel wall 64. On the other hand, the distance sensor 58 located front left in the travel direction signals a smaller distance than from the tunnel wall 64, specifically the distance d3′ from the oncoming vehicle 17. This smaller distance d3′ is filtered out, for example, by the filter 32 or by the plausibility means 37.

Of course, other arrangements are also possible, for example the selector module 29 could be contained in the lane module 30. The selector module 20 can also be a selector device which is separate from the driving assistance device 20, said selector device containing, for example, its own processor. In contrast with the exemplary embodiment in which an embodiment of the invention with hardware and software is illustrated, it is also possible to implement complete hardware solutions or complete software solutions.

1. A lane device for detecting the lane of a vehicle (10, 11, 12), the lane device (30) having evaluation means (32, 34, 37) for evaluating distance data (60, 61, 66) of at least one distance sensor (58, 59, 65), the distance data (60, 61, 66) containing information about a distance (d1-d4) from a reference body (62, 64) which runs essentially continuously to the side of the lane, at least in sections, and the evaluation means (32, 35, 37) being configured to acquire lane data (36) as a function of the distance data (60, 61, 66), characterized in that the evaluation means (32, 35, 37) filter out interference information, caused in particular by vehicles (17) present in the region of the lane or discontinuities (63) of the reference body (62, 64), from the distance data (60, 61, 66), the lane data (36) being acquired as a function of the filtered distance data (60, 61, 66).

2. The lane device as claimed in claim 1, characterized in that it contains at least one high pass filter and/or at least one low pass filter (31) for filtering the distance data (60, 61, 66).

3. The lane device as claimed in claim 1, characterized in that it carries out plausibility checking for the filtering of the distance data

4. The lane device as claimed in claim 1, characterized in that the evaluation means (32, 35, 37) compare the lane data (36) and/or the distance data (60, 61, 66) with stored lane data (45).

5. The lane device as claimed in claim 1, characterized in that the distance sensor (58, 59, 65) operates in a range of invisible or inaudible frequencies.

6. The lane device as claimed in claim 1, characterized in that the at least one distance sensor (58, 59, 65) is an ultrasonic sensor, a radar sensor or an infrared sensor.

7. The lane device as claimed in claim 1, characterized in that it can be activated, or activates itself, when there is an operative failure of a wirefree locating system, in particular of an GPS system (41), and/or where there is an operative failure of an optical detection system (40).

8. The lane device as claimed in claim 1, characterized in that the at least one distance sensor (58, 59, 65) forms a component of the lane device (30).

9. The lane device as claimed in claim 1, characterized in that the at least one distance sensor (58, 59, 65) forms a component of a parking aid device (28).

10. The lane device as claimed in claim 1, characterized in that it evaluates the distance data (60, 61, 66) of the at least one distance sensor (58, 59, 65) as a function of the velocity (v1) of the vehicle (10, 11, 12).

11. The lane device as claimed in claim 1, characterized in that it evaluates, and in particular weights, the distance data (60, 61, 66) as a function of the position of the at least one distance sensor (58, 59, 65) on the vehicle (10, 11, 12).

12. The lane device as claimed in claim 1, characterized in that it is configured to perform a transverse control of the vehicle (10, 11, 12), in particular to generate a steering intervention in the vehicle (10, 11, 12).

13. A selector device for interaction with a parking aid device (28) and with a lane device (30) as claimed in claim 1, having selection means for selecting the distance data (60, 61, 66) of the at least one distance sensor (58, 59, 65) as a function of the velocity of the vehicle (10, 11, 12) for the parking aid device (28) and/or for the lane device (30).

14. The selector device as claimed in claim 13, characterized in that the selection means is configured to make a direction-dependent selection of the distance data (60, 61, 66) of at least two distance sensors (58, 59, 65) as a function of their position on the vehicle (10, 11, 12).

15. The selector device as claimed in claim 13, characterized in that it forms a component of the lane device (30) or of the parking aid device (28).

16. The lane device as claimed in claim 1, characterized in that it has program code which can be executed by a processor (25).

17. A storage means having a lane device as claimed in claim 16.

18. A vehicle, in particular a passenger car, characterized in that it has a lane device (30) as claimed in claim 1.

19. A use of a distance sensor (58, 59, 65) which is a component of a parking aid device which is arranged in a vehicle (10), for providing distance data (60, 61, 66) which is fed to a lane device (30) as claimed in claim 1 which is also arranged in the vehicle (10), the lane device (30) acquiring lane data (36) from this distance data (60, 61, 66) in order to determine a lane (15) along which the vehicle (10) is guided.

20. A method for detecting the lane of a vehicle (10, 11, 12), having the following steps: evaluation of distance data (60, 61, 66) of at least one distance sensor (58, 59, 65), the distance data (60, 61, 66) containing information about a distance (d1-d4) from a reference body (62, 64) which runs essentially continuously to the side of the lane, at least in sections, and acquisition of lane data (36) as a function of the distance data (60, 61, 66), characterized in that interference information, caused by vehicles (17) present in the region of the lane or discontinuities (63) of the reference body (62, 64), are filtered out from the distance data (60, 61, 66), the lane data (36) being acquired as a function of the filtered distance data (60, 61, 66).

21. The selector device as claimed in claim 13, characterized in that it has program code which can be executed by a processor (25).

22. A storage means having a selector device as claimed in claim 21.

23. A vehicle, in particular a passenger car, characterized in that it has a selector device (29) as claimed in claim 13

24. A vehicle, in particular a passenger car, characterized in that it has a storage means as claimed in claim 22.
